(19) United States
(12) Patent Application Publication
(10) Pub. No.: US 2017/0229075 A1
(43) Pub. Date: Aug. 10, 2017

(54) DRIVING METHOD OF LIQUID CRYSTAL DISPLAY PANEL

(71) Applicant: SHENZHEN CHINA STAR OPTOELECTRONICS TECHNOLOGY CO., LTD., Shenzhen, Guangdong (CN)

(72) Inventor: Jiang ZHU, Shenzhen, Guangdong (CN)

(73) Assignee: Shenzhen China Star Optoelectronics Technology Co., Ltd., Shenzhen, Guangdong (CN)

(21) Appl. No.: 14/433,672

(22) PCT Filed: Jan. 9, 2015
(86) PCT No.: PCT/CN2015/070414

§ 371 Date: Apr. 5, 2015

(30) Foreign Application Priority Data
Dec. 30, 2014 (CN) 201410850936.3

(51) Int. Cl. G09G 3/36; G02F 1/13

(52) U.S. Cl. CPC G09G 3/3607; G02F 1/1323; G09G 2320/0233; G09G 2320/0673; G09G 2320/068

(57) ABSTRACT

A driving method of a liquid crystal display panel is provided. The driving method includes: defining a first area and a second area on the liquid crystal display panel; generating at least two first display grayscales according to each first to-be-displayed grayscale corresponding to the first area and generating at least two second display grayscales according to each second to-be-displayed grayscale corresponding to the second area; and using the at least two first display grayscales to respectively drive at least two first pixels in the first area to display and using the at least two second display grayscales to respectively drive at least two second pixels in the second area to display. Therefore, a displayed image observed in an oblique viewing angle would exhibit a disordered state, the liquid crystal display panel can achieve anti-peep effect and the privacy of user can be effectively protected.

### TECHNICAL FIELD

The invention relates to the field of display technology, and particularly to a driving method of a liquid crystal display panel.

### DESCRIPTION OF RELATED ART

At present, with the growing popularity of a variety of portable liquid crystal display (LCD) terminals, people use these LCD terminals everywhere in public places. However, sometimes these LCD terminals are used in public places to view or process some documents or applications with privacy, they are easy to be intentionally or unintentionally viewed by the around people, resulting in that the privacy is compromised.

### SUMMARY

Accordingly, embodiments of the invention provide a driving method of a liquid crystal display panel, which can make the liquid crystal display panel have anti-peep effect so as to effectively protect the privacy of user.

In order to solve the above technical problem, a technical solution provided by an embodiment of the invention is to provide a driving method of a liquid crystal display panel. The driving method includes steps of: defining a first area and a second area on the liquid crystal display panel, wherein the first area and the second area are set to be staggeredly arranged with each other; generating at least two first display grayscales according to each first to-be-displayed grayscale corresponding to the first area and generating at least two second display grayscales according to each second to-be-displayed grayscale corresponding to the second area, wherein at least a part of the at least two first display grayscales is/are set to be not equal to the first to-be-displayed grayscale, and the at least two second display grayscales are set to be equal to the second to-be-displayed grayscale; and using the at least two first display grayscales to respectively drive at least two first pixels in the first area to display and using the at least two second display grayscales to respectively drive at least two second pixels in the second area to display. When observing in a normal viewing angle, a corresponding relationship between an average value of actual displayed luminances of the at least two first pixels and the first to-be-displayed grayscale and a corresponding relationship between an average value of actual displayed luminances of the at least two second pixels and the second to-be-displayed grayscale satisfy a same gamma curve of normal viewing angle. When observing in an oblique viewing angle, a corresponding relationship between an average value of actual displayed luminances of the at least two first pixels and the first to-be-displayed grayscale and a corresponding relationship between an average value of actual displayed luminances of the at least two second pixels and the second to-be-displayed grayscale respectively satisfy different gamma curves of oblique viewing angle.

In an embodiment, before defining a first area and a second area on the liquid crystal display panel, the driving method further includes: adjusting sizes of the first area and the second area according to a control instruction.

In an embodiment, the step of generating at least two first display grayscales according to each first to-be-displayed grayscale corresponding to the first area and generating at least two second display grayscales according to each second to-be-displayed grayscale corresponding to the second area includes: setting the at least two first display grayscales corresponding to the same first to-be-displayed grayscale to be different from each other according to different control instructions.

In order to solve the above technical problem, another technical solution provided by an embodiment of the invention is to provide a driving method of a liquid crystal display panel. The driving method includes steps of: defining a first area and a second area on the liquid crystal display panel; generating at least two first display grayscales according to each first to-be-displayed grayscale corresponding to the first area and generating at least two second display grayscales according to each second to-be-displayed grayscale corresponding to the second area; and using the at least two first display grayscales to respectively drive at least two first pixels in the first area to display and using the at least two second display grayscales to respectively drive at least two second pixels in the second area to display. When observing in a normal viewing angle, a corresponding relationship between an average value of actual displayed luminances of the at least two first pixels and the first to-be-displayed grayscale and a corresponding relationship between an average value of actual displayed luminances of the at least two second pixels and the second to-be-displayed grayscale satisfy a same gamma curve of normal viewing angle. When observing in an oblique viewing angle, a corresponding relationship between an average value of actual displayed luminances of the at least two first pixels and the first to-be-displayed grayscale and a corresponding relationship between an average value of actual displayed luminances of the at least two second pixels and the second to-be-displayed grayscale respectively satisfy different gamma curves of oblique viewing angle.

In an embodiment, the step of defining a first area and a second area on the liquid crystal display panel includes: setting the first area and the second area to be staggeredly arranged with each other.

In an embodiment, before defining a first area and a second area on the liquid crystal display panel, the driving method further includes: adjusting sizes of the first area and the second area according to a control instruction.

In an embodiment, the step of generating at least two first display grayscales according to each first to-be-displayed grayscale corresponding to the first area and generating at least two second display grayscales according to each second to-be-displayed grayscale corresponding to the second area includes: setting at least a part of the at least two first display grayscales to be not equal to the first to-be-displayed grayscale, and setting the at least two second display grayscales to be equal to the second to-be-displayed grayscale.

In an embodiment, the step of generating at least two first display grayscales according to each first to-be-displayed grayscale corresponding to the first area and generating at least two second display grayscales according to each second to-be-displayed grayscale corresponding to the second area further includes: setting the at least two first display grayscales corresponding to the same first to-be-displayed grayscale to be different from each other according to different control instructions.

In order to solve the above technical problem, still another technical solution provided by an embodiment of the invention is to provide a driving method of a liquid crystal display panel. The driving method includes steps of: defining a first area and a second area on the liquid crystal display panel; generating two first display grayscales according to each first to-be-displayed grayscale corresponding to the first area and generating two second display grayscales according to each second to-be-displayed grayscale corresponding to the second area, wherein one of the two first display grayscales is greater than the first to-be-displayed grayscale and the other one is smaller than the first to-be-displayed grayscale, the two second display grayscales are equal to the second to-be-displayed grayscale; and using the two first display grayscales to respectively drive two first pixels in the first area to display and using the two second display grayscales to respectively drive two second pixels in the second area to display.

In an embodiment, the step of defining a first area and a second area on the liquid crystal display panel includes: setting the first area and the second area to be staggeredly arranged with each other.

In an embodiment, before defining a first area and a second area on the liquid crystal display panel, the driving method further includes: adjusting sizes of the first area and the second area according to a control instruction.

In an embodiment, the step of generating two first display grayscales according to each first to-be-displayed grayscale corresponding to the first area and generating two second display grayscales according to each second to-be-displayed grayscale corresponding to the second area includes: setting different the two first display grayscales corresponding to the same first to-be-displayed grayscale according to different control instructions.

In an embodiment, the step of generating two first display grayscales according to each first to-be-displayed grayscale corresponding to the first area and generating two second display grayscales according to each second to-be-displayed grayscale corresponding to the second area includes: generating two first display grayscales from the first to-be-displayed grayscale according to a gamma curve of normal viewing angle to make an average value of corresponding luminances of the two first display grayscales on the gamma curve of normal viewing angle be equal to a corresponding luminance of the first to-be-displayed grayscale on the gamma curve of normal viewing angle.

Based on the above technical solutions, the driving method of a liquid crystal display panel associated with embodiments of the invention defines a first area and a second area on the liquid crystal display panel and respectively generates different at least two display grayscales according to to-be-displayed grayscales corresponding to the two areas to drive pixels in the two areas to display, so that when observing in a normal viewing angle, relationships between average values of actual displayed luminances of pixels and respective corresponding to-be-displayed grayscales satisfy a same gamma curve of normal viewing angle, and when observing in an oblique viewing angle, relationships between average values of actual displayed luminances of pixels and respective corresponding to-be-displayed grayscales satisfy different gamma curves of oblique viewing angle, i.e., the displayed image exhibits a disordered state. Accordingly, the liquid crystal display panel can achieve anti-peep effect, and the privacy of user can be effectively protected.

### BRIEF DESCRIPTION OF THE DRAWINGS

In order to more clearly illustrate the technical solutions of various embodiments of the present invention, drawings will be used in the description of embodiments will be given a brief description below. Apparently, the drawings in the following description only are some embodiments of the invention, the ordinary skill in the art can obtain other drawings according to these illustrated drawings without creative effort. In the drawings:

FIG. 1 is a flowchart of an embodiment of a driving method of a liquid crystal display panel of the invention;

FIG. 2 is a schematic view of divided areas of an embodiment of a liquid crystal display panel of the invention;

FIG. 3 is a schematic view of pixel structures in first areas and second areas as shown in FIG. 2;

FIG. 4 is a schematic view of a gamma curve of normal viewing angle of an embodiment of the invention;

FIG. 5 is a schematic view of a gamma curve of oblique viewing angle corresponding to the second area as shown in FIG. 2; and

FIG. 6 is a schematic view of a gamma curve of oblique viewing angle corresponding to the first area as shown in FIG. 2.

### DETAILED DESCRIPTION OF EMBODIMENTS

In the following, with reference to accompanying drawings of embodiments of the invention, technical solutions in the embodiments of the invention will be clearly and completely described. Apparently, the embodiments of the invention described below only are a part of embodiments of the invention, but not all embodiments. Based on the described embodiments of the invention, all other embodiments obtained by ordinary skill in the art without creative effort belong to the scope of protection of the invention.

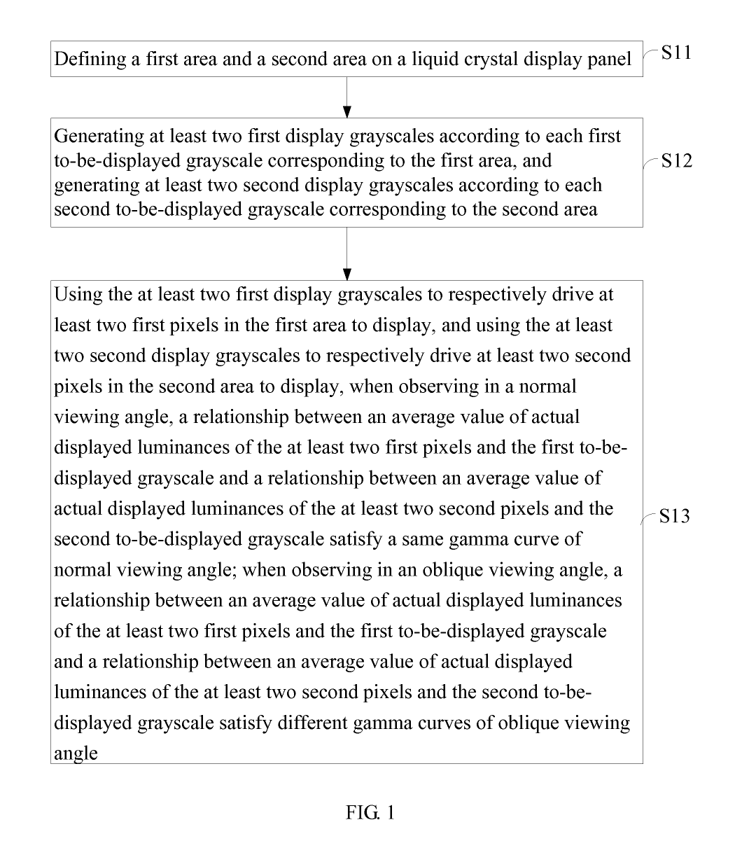

FIG. 1 is a flowchart of an embodiment of a driving method of a liquid crystal display panel of the invention. As shown in FIG. 1, the driving method of a liquid crystal display panel in this embodiment includes the following steps that:

Step S11: defining a first area and a second area on a liquid crystal display panel.

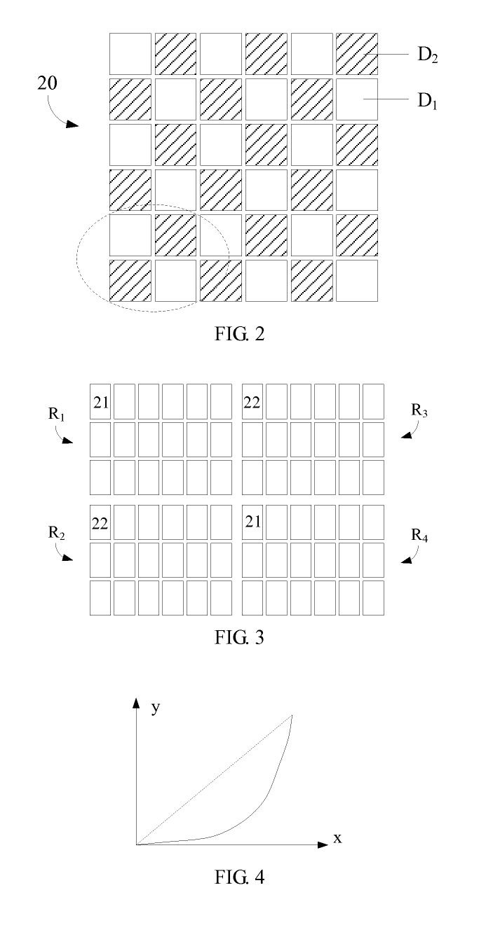

In particular, FIG. 2 is a schematic view of divided/defined areas of an embodiment of the liquid crystal display panel of the invention. As shown in FIG. 2, the liquid crystal display panel 20 with adjustable viewing angle function is defined with two types of display areas, i.e., first areas D₁ and second areas D₂.

FIG. 3 is a schematic view of pixel structures of the first areas and the second areas as shown in FIG. 2. As shown in FIG. 3, each first area D₁ includes at least two first pixels 21, each second area D₂ includes at least two second pixels 22, the first pixel 21 and the second pixel 22 have a same structure.

Step S12: generating at least two first display grayscales according to each first to-be-displayed grayscale corresponding to the first area, and generating at least two second display grayscales according to each second to-be-displayed grayscale corresponding to the second area.

When the step is concretely implemented, it may be that setting at least two display grayscales corresponding to a same first to-be-displayed grayscale to be different from each other according to different control instructions.

The first to-be-displayed grayscale is a grayscale required to be displayed by a plurality of first pixels 21 in the first area D₁ of the liquid crystal display panel 20, and the second to-be-displayed grayscale is a grayscale required to be displayed by a plurality of second pixels 22 in the second area D₂ of the liquid crystal display panel 20.

In this embodiment, it may be that setting at least a part of the at least two first display grayscales to be not equal to the first to-be-displayed grayscale and setting the at least two second display grayscales to be equal to the second to-be-displayed grayscale.

When two first display grayscales and two second display grayscales being generated is taken as an example, one of the generated two first display grayscales may be greater than the first to-be-displayed grayscale and the other one of the generated two first display grayscales may be smaller than the first to-be-displayed grayscale, and the generated two second display grayscales are equal to the second to-be-displayed grayscale.

Of course, the generated at least two second display grayscales may not be set to be equal to the second to-be-displayed grayscale, for example, at least a part of the at least two second display grayscales may be greater than the second to-be-displayed grayscale, and the other of the at least two second display grayscales may be smaller than the second to-be-displayed grayscale, i.e., the second area D₂ divides the second to-be-displayed grayscale same as that associated with the first area D₁.

Step S13: using the at least two first display grayscales to respectively drive at least two first pixels in the first area to display, and using the at least two second display grayscales to respectively drive at least two second pixels in the second area to display.

By driving at least two first pixels 21 in the first area D₁ and at least two second pixels 22 in the second area D₂ to display, an image will be displayed on the liquid crystal display panel 20.

When observing in a normal viewing angle:

A corresponding relationship between an average value of actual displayed luminances of the at least two first pixels 21 and the first to-be-displayed grayscale satisfies a gamma curve of normal viewing angle as shown in FIG. 4, a corresponding relationship between an average value of actual displayed luminances of the at least two second pixels 22 and the second to-be-displayed grayscale also satisfies the gamma curve of normal viewing angle as shown in FIG. 4. In the rectangular coordinates system, the vertical coordinate axis (y-axis) represents the average value of the actual displayed luminances and the horizontal coordinate axis (x-axis) represents the to-be-display grayscale.

For example, when the liquid crystal display panel 20 requires displaying an image with a grayscale of 128, i.e., the first to-be-displayed grayscale and the second to-be-displayed grayscale both are 128; first display grayscales corresponding to the first pixels 21 in the first area D₁ not all are 128, some may be 250, and some may be 50, but in the first area D₁, the average value of actual displayed luminances of at least two first pixels 21 is the same as an image effect of the grayscales thereof being 128. That is, when observing in the normal viewing angle, actual display luminances of the first area D₁ and the second area D₂ are the same.

When observing in an oblique viewing angle:

A corresponding relationship between an average value of actual displayed luminances of the at least two first pixels 21 and the first to-be-displayed grayscale and a corresponding relationship between an average value of actual displayed luminances of the at least two second pixels 22 and the second to-be-displayed grayscale respectively satisfy different gamma curves of oblique viewing angle.

For example, for the case of the generated at least two second display grayscales being equal to the second to-be-display grayscale, the at least two second pixels 22 in the second area D₂ would not generate alternate bright and dark displays, the corresponding relationship between the average value of actual displayed luminances of the at least two second pixels 22 and the second to-be-displayed grayscale satisfies a gamma curve of oblique viewing angle as shown in FIG. 5.

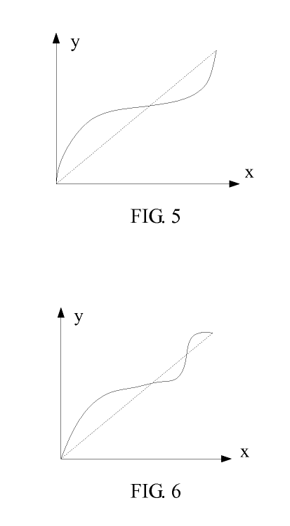

For the case of one of the generated at least two first display grayscales being greater than the first to-be-displayed grayscale and the other one being smaller than the first to-be-displayed grayscale, the at least two first pixels 21 in the first area D1 exhibit alternate bright and dark displays, the corresponding relationship between the average value of actual displayed luminances of the at least two first pixels 21 and the first to-be-displayed grayscale satisfies a gamma curve of oblique viewing angle as shown in FIG. 6, which is apparently different from the gamma curve of oblique viewing angle as shown in FIG. 5.

In conjunction with the illustrations of FIG. 2 and FIG. 3, the staggeredly-arranged two first areas D₁ and two second areas D₂ located in the region of FIG. 2 enclosed by dashed line are taken as an example, the diagonally arranged R₁, R₄ are the first areas D₁, and the diagonally arranged R₂, R₃ are the second areas D₂. In this embodiment, when observing in an oblique viewing angle, R₂, R₃ do not bright and dark alternately display while R₁, R₄ do bright and dark alternately display, so that the displayed image in the first areas D1 exhibits a disordered state, the liquid crystal display panel 20 achieves anti-peep effect, and the privacy of user can be effectively protected.

Of course, it should be understood that, this embodiment may be applied to the situation of generated at least two second display grayscales being not equal to the second to-be-displayed grayscale according to the grayscale setting of the first area D₁, so that when observing in an oblique viewing angel, the R₂, R₃ also do bright and dark alternately display, i.e., the displayed image in the second areas D₂ also exhibit a disordered state, so as to further improve the anti-peep effect.

In addition, the invention is not limited to set the first areas D₁ and the second areas D₂ to be staggeredly arranged as shown in FIG. 2, and sizes of the first areas D₁ and the second areas D₂ may be adjusted according to a control instruction of user, and the sizes may or may not be the same.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A driving method of a liquid crystal display panel, comprising:
defining a first area and a second area on the liquid crystal display panel, wherein the first area and the second area are set to be staggeredly arranged with each other;
generating at least two first display grayscales according to each first to-be-displayed grayscale corresponding to the first area and generating at least two second display grayscales according to each second to-be-displayed grayscale corresponding to the second area; wherein at least a part of the at least two first display grayscales is/are set to be not equal to the first to-be-displayed grayscale, and the at least two second display grayscales are set to be equal to the second to-be-displayed grayscale;
using the at least two first display grayscales to respectively drive at least two first pixels in the first area to display and using the at least two second display grayscales to respectively drive at least two second pixels in the second area to display, wherein
when observing in a normal viewing angle, a corresponding relationship between an average value of actual displayed luminances of the at least two first pixels and the first to-be-displayed grayscale and a corresponding relationship between an average value of actual displayed luminances of the at least two second pixels and the second to-be-displayed grayscale satisfy a same gamma curve of normal viewing angle;
when observing in an oblique viewing angle, a corresponding relationship between an average value of actual displayed luminances of the at least two first pixels and the first to-be-displayed grayscale and a corresponding relationship between an average value of actual displayed luminances of the at least two second pixels and the second to-be-displayed grayscale respectively satisfy different gamma curves of oblique viewing angle.

2. The driving method as claimed in claim 1, wherein before defining a first area and a second area on the liquid crystal display panel, further comprises:
adjusting sizes of the first area and the second area according to a control instruction.

3. The driving method as claimed in claim 1, wherein the step of generating at least two first display grayscales according to each first to-be-displayed grayscale corresponding to the first area and generating at least two second display grayscales according to each second to-be-displayed grayscale corresponding to the second area comprises:
setting the at least two first display grayscales corresponding to the same first to-be-displayed grayscale to be different from each other according to different control instructions.

4. A driving method of a liquid crystal display panel, comprising:
defining a first area and a second area on the liquid crystal display panel;
generating at least two first display grayscales according to each first to-be-displayed grayscale corresponding to the first area and generating at least two second display grayscales according to each second to-be-displayed grayscale corresponding to the second area;
using the at least two first display grayscales to respectively drive at least two first pixels in the first area to display and using the at least two second display grayscales to respectively drive at least two second pixels in the second area to display, wherein
when observing in a normal viewing angle, a corresponding relationship between an average value of actual displayed luminances of the at least two first pixels and the first to-be-displayed grayscale and a corresponding relationship between an average value of actual displayed luminances of the at least two second pixels and the second to-be-displayed grayscale satisfy a same gamma curve of normal viewing angle;
when observing in an oblique viewing angle, a corresponding relationship between an average value of actual displayed luminances of the at least two first pixels and the first to-be-displayed grayscale and a corresponding relationship between an average value of actual displayed luminances of the at least two second pixels and the second to-be-displayed grayscale respectively satisfy different gamma curves of oblique viewing angle.

5. The driving method as claimed in claim 4, wherein the step of defining a first area and a second area on the liquid crystal display panel comprises:
setting the first area and the second area to be staggeredly arranged with each other.

6. The driving method as claimed in claim 5, wherein before defining a first area and a second area on the liquid crystal display panel, further comprises:
adjusting sizes of the first area and the second area according to a control instruction.

7. The driving method as claimed in claim 4, wherein the step of generating at least two first display grayscales according to each first to-be-displayed grayscale corresponding to the first area and generating at least two second display grayscales according to each second to-be-displayed grayscale corresponding to the second area comprises:
setting at least a part of the at least two first display grayscales to be not equal to the first to-be-displayed grayscale, and setting the at least two second display grayscales to be equal to the second to-be-displayed grayscale.

8. The driving method as claimed in claim 7, wherein the step of generating at least two first display grayscales according to each first to-be-displayed grayscale corresponding to the first area and generating at least two second display grayscales according to each second to-be-displayed grayscale corresponding to the second area further comprises:
setting the at least two first display grayscales corresponding to the same first to-be-displayed grayscale to be different from each other according to different control instructions.

9. A driving method of a liquid crystal display panel, comprising:
defining a first area and a second area on the liquid crystal display panel;
generating two first display grayscales according to each first to-be-displayed grayscale corresponding to the first area and generating two second display grayscales according to each second to-be-displayed grayscale corresponding to the second area, wherein one of the two first display grayscales is greater than the first to-be-displayed grayscale and the other one is smaller than the first to-be-displayed grayscale, the two second display grayscales are equal to the second to-be-displayed grayscale;
using the two first display grayscales to respectively drive two first pixels in the first area to display and using the two second display grayscales to respectively drive two second pixels in the second area to display.

10. The driving method as claimed in claim 9, wherein the step of defining a first area and a second area on the liquid crystal display panel comprises:
setting the first area and the second area to be staggeredly arranged with each other.

11. The driving method as claimed in claim 10, wherein before defining a first area and a second area on the liquid crystal display panel, further comprises:
adjusting sizes of the first area and the second area according to a control instruction.

12. The driving method as claimed in claim 9, wherein the step of generating two first display grayscales according to each first to-be-displayed grayscale corresponding to the first area and generating two second display grayscales according to each second to-be-displayed grayscale corresponding to the second area comprises:
setting different the two first display grayscales corresponding to the same first to-be-displayed grayscale according to different control instructions.

13. The driving method as claimed in claim 9, wherein the step of generating two first display grayscales according to each first to-be-displayed grayscale corresponding to the first area and generating two second display grayscales according to each second to-be-displayed grayscale corresponding to the second area comprises:
generating two first display grayscales from the first to-be-displayed grayscale according to a gamma curve of normal viewing angle to make an average value of corresponding luminances of the two first display grayscales on the gamma curve of normal viewing angle be equal to a corresponding luminance of the first to-be-displayed grayscale on the gamma curve of normal viewing angle.
